(19) United States
(12) Patent Application Publication
(10) Pub. No.: US 2011/0016343 A1
(43) Pub. Date: Jan. 20, 2011

(54) Synchronizing a Clock in a Vehicle Telematic System

(75) Inventor: Nathan Hoch, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 12/503,193

(22) Filed: Jul. 15, 2009

(51) Int. Cl. G06F 1/12

(52) U.S. Cl. 713/400

(57) ABSTRACT

A telematic module (12) in a mobile vehicle (10) has an internal clock that is synchronized with a master clock signal by an algorithm (22) that has a sequence of steps for determining if each of a number of master clock signals from respective master clock sources external to the vehicle is being received by a receiver, such as an antenna system (14). A processing system of the module executes the steps in an ordered priority assigned to the master clock sources from highest priority to lowest priority until one of the steps discloses availability of the corresponding master clock signal. Then the internal clock is synchronized (30) to that corresponding master clock signal.

### FIELD OF THE INVENTION

This invention relates to vehicle telematic systems that utilize extremely accurate external clock sources, such as a clock in the Global Positioning System (GPS), to set the time of internal clocks.

### BACKGROUND OF THE INVENTION

A vehicle telematic system embodies wireless technology and GPS tracking technology that collectively enable data to be exchanged between the vehicle and a location remote from the vehicle. For example, data related to operation of multiple vehicles in a fleet can be automatically relayed from each vehicle to a central location that monitors the fleet for various purposes such vehicle diagnostics or tracking package delivery to customers. Similarly, the central location can transmit data to the fleet vehicles. The data, which may include voice data, is typically communicated through cellular towers.

A telematic system typically comprises a telematic module that has a data processing system that can vary in complexity depending on the amount and type of data being processed. Data to be processed may be generated internally of a vehicle or received wirelessly from an external source such as a GPS satellite or a cellular tower. The processing of internally generated data yields results that may be used internally and/or transmitted wirelessly. The processing of wirelessly received data may be converted to audio or video information for a driver of the vehicle.

For assuring proper processing of data and for coordination of various processing functions so that information will be correctly presented to both a recipient in the vehicle and one at a remote location, the data processing system in a telematic module relies on a highly accurate master clock signal such as one provided by the Global Positioning System. A telematic module may have one or more internal clocks, hardware- and/or software-based, that is or are synchronized with the master clock signal provided by the Global Positioning System. Because internal clocks are inherently subject to drift, they are frequently synchronized with the GPS master clock signal.

The inventor has observed that because the GPS master clock signal may be inaccessible when a telematic module's clock is to be synchronized, drift may go uncorrected for more than a desired time interval between synchronizations that is deemed proper for avoiding undesired drift.

### SUMMARY OF THE INVENTION

The present invention provides a solution that mitigates drift that might otherwise occur in a telematic module's clock should the external master clock signal be unavailable when synchronization is scheduled.

Briefly, the invention provides a telematic module with an algorithm that is effective, when clock synchronization is scheduled but the master clock signal is unavailable, to seek a clock signal from a substitute master clock using a list of master clock sources in an ordered priority of potentially available master clock sources. The algorithm seeks to determine the availability of the highest priority master clock in the list, typically the GPS master clock, and if it is available, then it is used to synchronize the internal clock. If the highest priority master clock signal is unavailable, then the algorithm seeks to determine the availability of the next highest priority master clock in the list, and so on down the list in order of decreasing priority until one of the master clock sources is found available to the telematic module, and consequently used in substitution of the presently unavailable higher priority sources.

One general aspect of the invention relates to a method of synchronizing an internal clock of a vehicle telematic module to a master clock. The method comprises: executing, in a processor that is on-board a vehicle, an algorithm that comprises a sequence of steps for determining if each of a number of master clock signals from respective master clock sources, at least some of which are external to the vehicle, is available to the processor by executing the steps in an ordered priority assigned to the master clock sources from highest priority to lowest priority until one of the steps discloses availability of the corresponding master clock signal, and then synchronizing the internal clock to that corresponding master clock signal.

Another general aspect of the invention relates to a mobile vehicle comprising an on-board telematic module comprising a data processing system for processing data and an internal clock associated with operation of the data processing system, and a receiver such as an antenna system via which data is wirelessly transmitted from and received by the vehicle.

The processing system comprises an algorithm that comprises a sequence of steps for determining if time data from master clock sources, including the external master clock sources, is available to the processing system, and the processing system executes the steps in an ordered priority assigned to the master clock sources from highest priority to lowest priority until one of the steps discloses availability of the corresponding master clock signal, and then the processing system synchronizes the internal clock to that corresponding master clock signal.

The foregoing, along with further aspects, features, and advantages of the invention, will be seen in the following disclosure of a presently preferred embodiment of the invention depicting the best mode contemplated at this time for carrying out the invention. The disclosure includes drawings, briefly described as follows.

### BRIEF DESCRIPTION OF THE DRAWINGS

FIG. 1 is a general schematic diagram showing a typical vehicle telematic communications system providing bi-directional communication between a mobile vehicle and a remote location via a wireless interface that comprises a land-based cellular radio system.

FIG. 2 is a schematic block diagram showing the inventive algorithm embodied in a data processor of a telematic module in the vehicle.

### DESCRIPTION OF THE PREFERRED EMBODIMENT

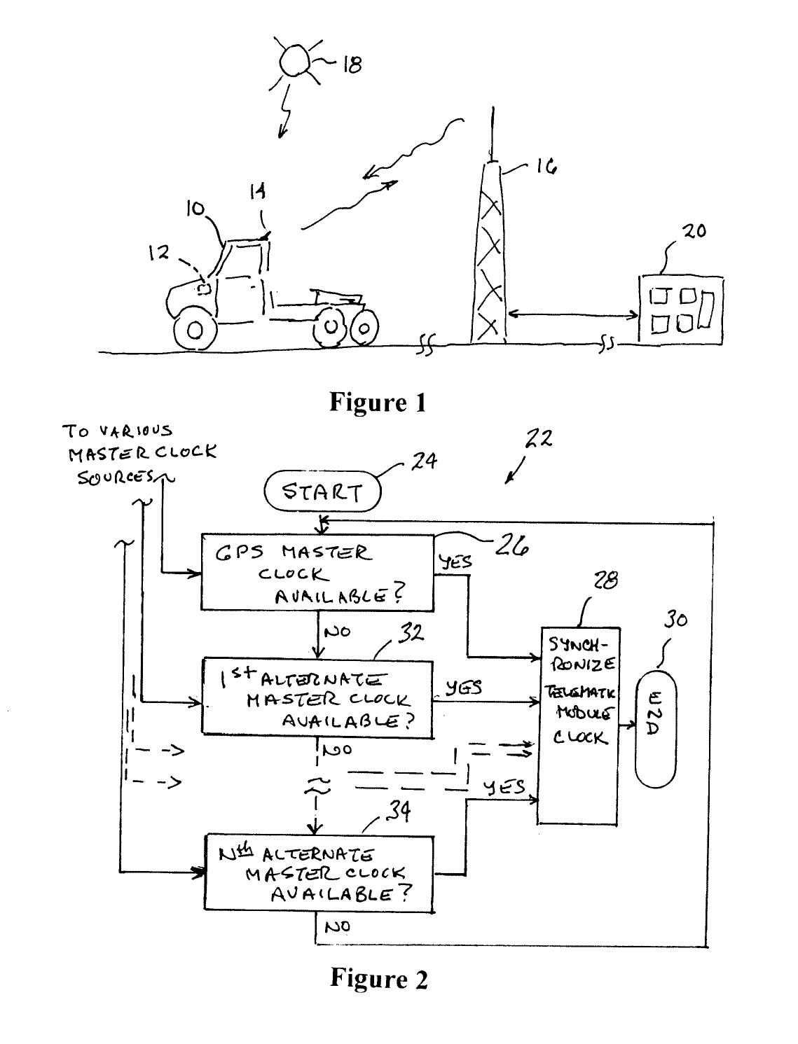

FIG. 1 shows a mobile vehicle 10, a truck for example, having a telematic module 12, and an antenna system 14 through which module 12 can wirelessly communicate bi-directionally with a tower 16 in a cellular communications system and/or with one or more satellites 18 of the Global Positioning System. The cellular communications system provides bi-directional communication with a land-based location 20, such as a control center, remote from vehicle 10 to complete the transmission path between the vehicle and the remote location.

Telematic module 12 comprises a data processing system, such as one or more processors, for processing various data as explained earlier. One or more internal clocks, hardware- and/or software-based, are associated with the data processing system to provide system time. Such clocks are used when a master clock signal from the Global Positioning System is unavailable, but they are inherently subject to drift. The drift is typically corrected by regularly synchronizing the internal clock or clocks with the master clock signal provided by the GPS.

FIG. 2 shows the inventive algorithm 22 that is executed when internal clock synchronization is called for. The algorithm has a start, or entry, point 24 with the algorithm commencing by executing a step 26 that seeks to use the highest priority master clock, the GPS master clock in this example, for internal clock synchronization. So long as the GPS master clock signal is being received through antenna system 14 and supplied to module 12, step 26 selects it for use in the synchronizing step 28 after which the execution of the algorithm ends (reference numeral 30).

Had the GPS master clock signal been unavailable, then the algorithm would seek to use the next highest priority master clock as a first alternate source for internal clock synchronization by executing a step 32. So long as the first alternate source master clock signal is being received through antenna system 14 and supplied to module 12, step 32 selects it for use in the synchronizing step 28 after which the execution of the algorithm ends (reference numeral 30).

Had the first alternate master clock signal been unavailable, then the algorithm would seek to use the next highest priority master clock as a second alternate source for internal clock synchronization, and if available, it would be used.

It should therefore be appreciated that the algorithm continues to execute until it finds an available source among potentially available sources. Should it fail to find any available source in the prioritized list of master clock sources, then after seeking the last (N^{th}) source 34 in the list the algorithm iterates through the list from the start, and continues to do so until an available source is found. However in some instances, there may be a system-specific delay before the algorithm is executed again.

Examples of external alternate master clock sources include NIST Radio Station WWVB and LORAN positioning. A potential alternate master clock source could be internal to the vehicle, and its availability could be determined by a step of the algorithm according to its assigned priority. Such an internal source could be another in-vehicle electronic module whose clock signal may be available on an in-vehicle communication bus (for example, J1939, J1587, Flex-Ray, J1850, etc.).

Clock signals from certain master clock sources may be transmitted optically rather than by radio transmission, in which case the vehicle antenna system would comprise an optical receiver.

While a presently preferred embodiment of the invention has been illustrated and described, it should be appreciated that principles of the invention are applicable to all embodiments that fall within the scope of the following claims.

What is claimed is:

1. A method of synchronizing an internal clock of a vehicle telematic module to a master clock that comprises:
executing, in a processor that is on-board a vehicle, an algorithm that comprises a sequence of steps for determining if each of a number of master clock signals from respective master clock sources at least some of which are external to the vehicle is available to the processor by executing the steps in an ordered priority assigned to the master clock sources from highest priority to lowest priority until one of the steps discloses availability of the corresponding master clock signal, and then synchronizing the internal clock of the vehicle telematic module to that corresponding master clock signal.

2. A method as set forth in claim 1 comprising assigning highest priority to the master clock signal received by a receiver in the vehicle from the Global Positioning System.

3. A method as set forth in claim 1 comprising iterating the steps after a first iteration of the steps has disclosed no available master clock signals, continuing iterating to until a master clock signal is found available, and then using the latter signal to synchronize the internal clock.

4. A mobile vehicle comprising:
an on-board telematic module comprising a data processing system for processing data and an internal clock associated with operation of the data processing system; and
a receiver via which data, including time data from master clock sources that are external to the vehicle, is wirelessly received by the vehicle;
wherein the processing system comprises an algorithm that comprises a sequence of steps for determining if time data from master clock sources, including the external master clock sources, is available to the processing system, and the processing system executes the steps in an ordered priority assigned to the master clock sources from highest priority to lowest priority until one of the steps discloses availability of the corresponding master clock signal, and then the processing system synchronizes the internal clock to that corresponding master clock signal.

5. A mobile vehicle as set forth in claim 4 wherein the algorithm is arranged to assign highest priority to the master clock signal received through the receiver from the Global Positioning System.

6. A mobile vehicle as set forth in claim 4 wherein the algorithm is arranged to iterate the steps after a first iteration of the steps has disclosed no available master clock signals, to continue iterating to until a master clock signal is determined to be available, and then to use the latter signal to synchronize the internal clock.
